(19) United States
(12) Patent Application Publication
(10) Pub. No.: US 2013/0113407 A1
(43) Pub. Date: May 9, 2013

(54) CONTROL SYSTEM WITH REMOTE DRIVERS

(71) Applicants: VIJAY A. NEELAKANTAN, ROCHESTER HILLS, MI (US); BRET M. OLSON, WHITELAKE, MI (US)

(72) Inventors: VIJAY A. NEELAKANTAN, ROCHESTER HILLS, MI (US); BRET M. OLSON, WHITELAKE, MI (US)

(73) Assignee: GM GLOBAL TECHNOLOGY OPERATIONS LLC, DETROIT, MI (US)

(21) Appl. No.: 13/292,817

(22) Filed: Nov. 9, 2011

(51) Int. Cl. H02P 7/29; F16H 61/02

(52) U.S. Cl. 318/494; 701/60

(57) ABSTRACT

A control system for a transmission includes a transmission control module having a processor configured to determine an output torque command and having a pulse width modulation (PWM) switch configured to generate a PWM signal at least partially representative of the output torque command. A network is in communication with the transmission control module and is configured to receive and transmit the PWM signal. A driver is integrated with the electromagnetic actuator and is in communication with the network. The driver is configured to receive the PWM signal and convert the PWM signal into a drive current that enables the electromagnetic actuator to fulfill the output torque command.

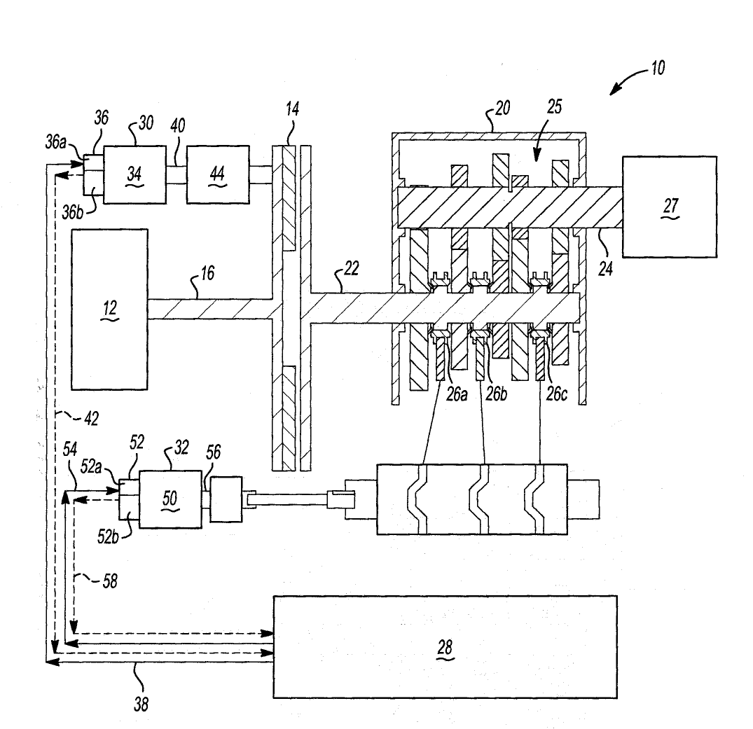

### FIELD

The present disclosure relates to a control system for a transmission having remote drivers, and more particularly to a control system having an integrated motor driver for electromechanical gear and clutch actuation in a transmission.

### BACKGROUND

The statements in this section merely provide background information related to the present disclosure and may or may not constitute prior art.

Automatic and manual transmissions in motor vehicles employ an electronic control module to control the operation of the transmission. The electronic control module receives electronic inputs from various sensors on the vehicle and processes that information to determine the vehicle's operating conditions. Depending on these operating conditions the electronic control module controls transmission upshifts and downshifts, transmission shift feel, and starting device apply and release timing. Electronic control of these transmission operating characteristics provides for consistent and precise shift points and shift quality based on the operating conditions of the vehicle.

Depending on the transmission architecture, the electronic module may actuate multiple electromagnetic actuators. Accordingly, for any given transmission architecture, the electronic control module must specific to that architecture and have the appropriate motor or electromagnetic drivers to properly drive the electromagnetic actuators. While these systems have proven effective, there is room in the art for an electronic control system that decentralizes the driver control of the electromagnetic actuators which may enable the re-use of the same electronic control module across various transmission architectures.

### SUMMARY

A control system for a transmission in a motor vehicle is provided. The control system is operable to control an electromagnetic actuator in a transmission. The system includes a transmission control module having a processor configured to determine an output torque command and having a pulse width modulation (PWM) switch configured to generate a PWM signal at least partially representative of the output torque command. A network is in communication with the transmission control module and is configured to transmit the PWM signal. A driver is integrated with the electromagnetic actuator and is in communication with the network. The driver is configured to receive the PWM signal and convert the PWM signal into a drive current to the appropriate phases that enables the electromagnetic actuator to fulfill the output torque command.

In one aspect, the system further includes a position sensor integrated with the electromagnetic actuator and in communication with the network, wherein the position sensor is configured to detect a magnitude of rotation of the electromagnetic actuator and to generate a signal, which may be CAN, PWM, analog or another type of signal to the transmission control module at least partially representative of the magnitude of rotation.

In another aspect, the transmission control module determines the output torque command at least partially based on the PWM signal from the position sensor.

In yet another aspect, the network is a controller area network bus.

A transmission is also provided and includes an input shaft, an output shaft, a gearbox coupled to the input shaft and the output shaft, wherein the gearbox includes at least one torque transmitting mechanism selectively engageable to provide one or more speed ratios between the input shaft and the output shaft, and an actuator coupled to the torque transmitting mechanism, wherein the actuator is positioned to selectively engage the torque transmitting mechanism. A motor unit including an electric motor and a driver integrated into the electric motor includes a rotor coupled to the actuator, wherein an output torque applied to the rotor by the electric motor positions the actuator. The transmission also includes a transmission control module having a processor configured to determine an output torque command and having a pulse width modulation (PWM) switch configured to generate a PWM signal at least partially representative of the output torque command and a network in communication with the transmission control module and the driver of the motor unit. The motor driver is configured to receive the PWM signal and convert the PWM signal into drive currents corresponding to the different phases of the motor windings that enables the electric motor to provide the commanded output torque to the rotor to position the actuator.

Further aspects, advantages and areas of applicability will become apparent from the description provided herein. It should be understood that the description and specific examples are intended for purposes of illustration only and are not intended to limit the scope of the present disclosure.

### DRAWING

The drawing described herein is for illustration purposes only and is not intended to limit the scope of the present disclosure in any way.

The drawing is a schematic view of a powertrain of a motor vehicle according to the principles of the present invention.

### DETAILED DESCRIPTION

The following description is merely exemplary in nature and is not intended to limit the present disclosure, application, or uses.

With reference to the drawing, an exemplary powertrain for a motor vehicle is generally indicated by reference number 10. The powertrain 10 includes an engine 12 for providing power and torque to propel the motor vehicle. The engine 12 may be a conventional internal combustion engine or an electric motor, or any other type of prime mover, without departing from the scope of the present disclosure. The engine 12 is configured to provide driving torque to a launch or starting device 14 through an engine output shaft 16. The engine output shaft 16 may be connected to the starting device 14 through a flexplate (not shown) or other connecting device. The starting device 14 may be a hydrodynamic device, such as a fluid coupling or torque converter, an electric motor, or a friction device such as a dry or wet launch clutch or dual clutch. It should be appreciated that any type of starting device 14 may be employed without departing from the scope of the present disclosure.

The starting device 14 transfers drive torque to an automatic transmission 20. The transmission 20 may be a front wheel drive transmission or a rear wheel drive transmission. Generally speaking, the transmission 20 includes a transmission input shaft 22 and a transmission output shaft 24. The transmission input shaft 22 is functionally interconnected with the engine 12 via the starting device 14 and receives input torque or power from the engine 12. Accordingly, the transmission input shaft 22 may be a turbine shaft in the case where the starting device 14 is a hydrodynamic device, dual input shafts where the starting device 14 is dual clutch, or a drive shaft where the starting device 14 is an electric motor. Disposed between the transmission input shaft 22 and the transmission output shaft 24 is a gear and clutch arrangement 25. The gear and clutch arrangement 25 may include a plurality of gear sets, a plurality of clutches and/or brakes, a plurality of synchronizers, and/or a plurality of shafts. The plurality of gear sets may include individual intermeshing gears, such as planetary gear sets or co-planar gear sets, that are connected to or selectively connectable to the plurality of shafts through the selective actuation of the plurality of clutches/brakes or synchronizers. The plurality of shafts may include layshafts or countershafts, sleeve and center shafts, reverse or idle shafts, or combinations thereof. The clutches/brakes and synchronizers are selectively engageable to initiate at least one of a plurality of gear or speed ratios by selectively coupling individual gears within the plurality of gear sets to the plurality of shafts. It should be appreciated that the specific arrangement and number of the gear sets, clutches/brakes, and shafts within the transmission 20 may vary without departing from the scope of the present disclosure. For purposes of example, the transmission 20 is illustrated as a layshaft transmission having three synchronizer assemblies 26A, 26B, and 26C and a single launch clutch 14. However, as discussed above, the transmission 20 may take various forms without departing from the scope of the present invention.

The transmission output shaft 22 is preferably connected with a final drive unit 27. The final drive unit 26 may include, for example, propshafts, differential assemblies, drive axles and wheels.

The transmission 20 also includes a transmission control module 28. The transmission control module 28 is preferably an electronic control device having a preprogrammed digital computer or processor, control logic, memory used to store data, and at least one I/O peripheral such as a pulse width modulation switch. The control logic includes a plurality of logic routines for monitoring, manipulating, and generating data. The transmission control module 28 is in electronic communication with a first motor unit 30 and a second motor unit 32. It should be appreciated that the transmission control module 28 may be in electronic communication with any number of motor units without departing from the scope of the present invention.

The first motor unit 30 includes an electric motor 34 with an integrated electronics package 36. The electric motor 34 is preferably a brushless DC motor. However, the electric motor 34 may also be any electromagnetic machine such as, for example, a brushed motor or a stepper motor. The integrated electronics package 36 includes a motor driver circuit 36A that provides an interface between signal processing circuitry, i.e. the controller 28, and the electric motor 34 and is used to drive the electric motor 34 based on command signals from the controller 28. These command signals are represented by the solid line 38 shown in the drawing and are preferably pulse-width modulated signals communicated via a computer aided network. The integrated electronics package 36 also includes a position sensor 36B for sensing a position of a rotor 40 of the electric motor 30. The position sensor 36B communicates position feedback to the controller 28 via a controller area network (CAN) bus, represented by the dashed line 42 shown in the drawing. Alternatively, the position sensor 36B may be a separate electronics package from the electronics package 36. The rotor 40 of the first motor unit 30 is coupled to an actuator 44 for engaging the starting device 14.

The second motor unit 32 includes an electric motor 50 with an integrated electronics package 52. The electric motor 50 is preferably a brushless DC motor. However, the electric motor 50 may also be any electromagnetic machine such as, for example, a brushed motor or a stepper motor. The integrated electronics package 52 includes a motor driver circuit 52A that provides an interface between signal processing circuitry, i.e. the controller 28, and the electric motor 50 and is used to drive the electric motor 50 based on command signals from the controller 28. These command signals are represented by the solid line 54 shown in the drawing and are preferably pulse-width modulated signals communicated via controller area network (CAN) or other electrical wiring. The integrated electronics package 52 also includes a position sensor 52B for sensing a position of a rotor 56 of the electric motor 50. The position sensor 52B communicates position feedback to the controller 28 via a computer aided network, represented by the dashed line 58 shown in the drawing. Alternatively, the position sensor 52B may be a separate electronics package from the electronics package 52. The rotor 56 of the second motor unit 32 is coupled to a gear 60 that drives a barrel cam 62. The barrel cam 62 is configured to engage the plurality of synchronizers 26A-C.

During operation of the powertrain 10, the position sensor 36B sends real-time position data of the rotor 40 to the controller 28. The controller 28 receives the real-time position data and performs closed-loop control calculations to determine a required torque command to the first motor unit 30. The torque command is converted by the controller 28 into a pulse width modulated (PWM) signal and communicated to the motor driver 36A. The motor driver 36A receives the PWM signal and based on the PWM signal commands an appropriate current to the electric motor 34 in order to produce the required torque. The second motor unit 32 operates in a substantially similar manner as the first motor unit 30.

The integration of the entire motor driver inside a single motor unit generally provides the highest level of functionality at the lowest cost and physical size. This further allows using existing transmission control modules to control multiple types of transmissions, including dual clutch transmissions, manual transmissions, or planetary gear transmissions.

The description of the invention is merely exemplary in nature and variations that do not depart from the gist of the invention are intended to be within the scope of the invention. Such variations are not to be regarded as a departure from the spirit and scope of the invention.

The following is claimed:

1. A system for controlling a plurality of actuators in a transmission, the system comprising:
a transmission control module having a processor in communication with a control circuit configured to generate a control signal indicative of an actuator control command to place the transmission in a desired operating state;
a network in communication with the transmission control module and configured to receive the control signal; and
an actuator control module in communication with at least one of the plurality of actuators and in communication with the network, the actuator control module configured to receive the control signal and to place the transmission in the desired operating state.

2. The system of claim 1 further comprising a position sensor in communication with the at least one of the plurality of actuators and in communication with the network, wherein the position sensor is configured to detect a position of the at least one of the plurality of actuators and to generate a feedback signal to the transmission control module at least partially representative of the position.

3. The system of claim 2 wherein the transmission control module determines the actuator control command at least partially based on the feedback signal from the position sensor.

4. The system of claim 1 wherein the network is a controller area network bus.

5. A control system for a transmission, the control system comprising:
a transmission control module having a processor configured to determine an output torque command and having a pulse width modulation (PWM) switch configured to generate a PWM signal at least partially representative of the output torque command;
a network in communication with the transmission control module and configured to transmit the PWM signal;
a motor unit including an electric motor and a driver integrated into the electric motor, wherein the driver is in communication with the network and is configured to receive the PWM signal and convert the PWM signal into a drive current that enables the electric motor to fulfill the output torque command.

6. The control system of claim 5 wherein the electric motor includes a rotor that provides an output torque, and wherein the control system further comprises a position sensor integrated with the electric motor and in communication with the network, wherein the position sensor is configured to detect a magnitude of rotation of the rotor and to generate a CAN, PWM, analog or other type of signal to the transmission control module at least partially representative of the magnitude of rotation of the rotor.

7. The system of claim 6 wherein the transmission control module determines the output torque command at least partially based on the feedback signal from the position sensor.

8. The system of claim 7 wherein the output torque command determined by the transmission control module is a function of real-time position data communicated from the position sensor to the transmission control module.

9. The system of claim 8 wherein the transmission control module determines the output torque command using closed loop control calculations.

10. The system of claim 6 wherein the network includes a controller area network bus.

11. A transmission comprising:
an input shaft;
an output shaft;
a gearbox coupled to the input shaft and the output shaft, wherein the gearbox includes at least one torque transmitting mechanism selectively engageable to provide one or more speed ratios between the input shaft and the output shaft;
an actuator coupled to the torque transmitting mechanism, wherein the actuator is positioned to selectively engage the torque transmitting mechanism;
a motor unit including an electric motor and a driver integrated into the electric motor, wherein the electric motor includes a rotor coupled to the actuator, and wherein an output torque applied to the rotor by the electric motor positions the actuator;
a transmission control module having a processor configured to determine an output torque command and having a pulse width modulation (PWM) switch configured to generate a PWM signal at least partially representative of the output torque command; and
a network in communication with the transmission control module and the driver of the motor unit, and
wherein the driver is configured to receive the PWM signal and convert the PWM signal into a drive current that enables the electric motor to provide the commanded output torque to the rotor to position the actuator.

12. The control system of claim 11 further comprising a position sensor coupled with the electric motor and in communication with the network, wherein the position sensor is configured to detect a magnitude of rotation of the rotor and to generate a CAN, PWM, analog, or other type of signal to the transmission control module at least partially representative of the magnitude of rotation of the rotor.

13. The system of claim 12 wherein the transmission control module determines the output torque command at least partially based on the signal from the position sensor.

14. The system of claim 13 wherein the output torque command determined by the transmission control module is a function of real-time position data communicated from the position sensor to the transmission control module.

15. The system of claim 14 wherein the transmission control module determines the output torque command using closed loop control calculations.

16. The system of claim 11 wherein the network includes a controller area network bus.
